(19) United States
(12) Patent Application Publication
(10) Pub. No.: US 2014/0126371 A1
(43) Pub. Date: May 8, 2014

(54) FLOW SWITCH AND OPERATING METHOD THEREOF

(71) Applicant: Electronics and Telecommunications Research Institute, Daejeon (KR)

(72) Inventors: Kang Il Choi, Daejeon (KR); Bhum Cheol Lee, Daejeon (KR); Jung Hee Lee, Daejeon (KR); Young Ho Park, Daejeon (KR); Sang Min Lee, Daejeon (KR); Seung Woo Lee, Daejeon (KE)

(73) Assignee: Electronics and Telecommunications Research Institute, Daejeon (KR)

(21) Appl. No.: 14/061,862

(22) Filed: Oct. 24, 2013

(30) Foreign Application Priority Data
Nov. 8, 2012 (KR) 10-2012-0126298
Aug. 7, 2013 (KR) 10-2013-0093677

(51) Int. Cl. H04L 12/851; H04L 12/931

(52) U.S. Cl. CPC H04L 47/24; H04L 49/70
USPC 370/235

(57) ABSTRACT

An exemplary embodiment of the present invention provides a flow switch, and an operating method thereof, and more particularly, to a flow switch for providing network virtualization, in which a quality of service (QoS) for a packet for each virtual machine is easily secured through flow information extracted from each of a plurality of packets when the plurality of packets generated by a plurality of virtual machines is input in a server virtualization environment, and an operating method thereof.

### CROSS-REFERENCE TO RELATED APPLICATIONS

This application claims priority to and the benefit of Korean Patent Application No. 10-2013-0093677 filed on Aug. 7, 2013, and 10-2012-0126298 filed on Nov. 8, 2012 in the Korean Intellectual Property Office the entire contents of which are incorporated herein by reference.

### TECHNICAL FIELD

The present invention relates to a flow switch, and an operating method thereof, and more particularly, to a flow switch for providing network virtualization, in which a quality of service (QoS) for a packet for each virtual machine is easily secured through flow information extracted from each of a plurality of packets when the plurality of packets generated by a plurality of virtual machines is input in a server virtualization environment, and an operating method thereof.

### BACKGROUND ART

Recently, as a semiconductor technology is developed, performance of a computer processor is highly improved, and as a multi core processor technology is developed, the amount of operations simultaneously operable in one computer server is remarkably increased. A minimum of several tens to a maximum of several hundreds of computer servers are installed in a private data center of a business or financial field to provide services in the business or financial field (business finance, finance, stocks, and the like). In an Internet data center (IDC), several hundreds or several thousands of computer servers are installed at one place, so that various and stable services (a web server, a mail server, a file server, a video server, and a cloud server, and the like) are provided to different service users. In this environment, a decrease in costs and simplification of a management by integrally operating the server is demanded, and a necessity to control a large-sized multi processor, such as a server storage place or a render farm, and cluster equipment is also raised. Demands for security, reliability, and independency of equipment have also increased. Especially, an execution of an application program dependent on a specific operating system in a different hardware or operating system environment is required.

In order to meet the requirements, a concept of server virtualization emerges. In the server virtualization environment, one or more different virtual machines (several, several tens, or several hundreds of virtual machines) may exist in one computer server. There is a hypervisor (or a virtual machine monitor (VMM)) sharing and simultaneously executing hardware (a CPU, a memory, a storage, a network interface, and the like) resources of a computer server in which several (several tens or several hundreds of) different virtual machines are virtualized. The hypervisor performs functions, such as a generation of a virtual machine within a server, a removal of a virtual machine, and a management of resources of virtual machines. The hypervisor enables the virtual machines to share a network and a storage. In a case of the storage, when the hypervisor is set so that each virtual machine uses a storage of a logically or physically divided region, the virtual machines may share the entire storage without interfering each other. However, in a case of the network, several virtual machines (several tens or several hundreds of virtual machines) installed in one computer server generally share one or more network devices. When one or more network devices are shared by one or more virtual machines, one or more virtual machines need to be provided so that the virtual machines share a network without interfering each other in a network level for each virtual machine.

Researches on a network virtualization technology for solving the aforementioned problems have been recently conducted.

### SUMMARY OF THE INVENTION

The present invention has been made in an effort to provide a flow switch capable of easily providing a service at a stable speed even though the number of virtual machines connected to a hypervisor is increased by extracting flow information about each of a plurality of packets and providing network virtualization, in which a quality of service is secured according to QoS information set by using the flow information and information about a virtual machine extracting the flow information, when the plurality of packets generated by the plurality of virtual machines in a server virtualization environment is transmitted through the hypervisor, and an operating method thereof.

An exemplary embodiment of the present invention provides a flow switch including: a virtual flow recognition switch unit configured to receive a plurality of packets transmitted from hypervisors through a network interface, and process the plurality of packets; a flow determination unit configured to extract flow information corresponding to each of the plurality of packets, and determine whether there is stored previous flow information matched with the flow information; and a packet processing control unit configured to check whether the flow information is included in predetermined QoS limitation information when there is the previous flow information, control the virtual flow recognition switch unit so that a corresponding packet, from which the flow information is extracted, is processed by applying previous QoS policy information matched with the previous flow information when the flow information is included in the QoS limitation information, and control the virtual flow recognition switch unit so that the corresponding packet is processed without applying the previous QoS policy information when the flow information is not included in the QoS limitation information.

Another exemplary embodiment of the present invention provides a method of operating a flow switch, including: extracting flow information corresponding to each of a plurality of packets when the plurality of packets is transmitted from hypervisors through a network interface; determining whether there is stored previous flow information matched with the flow information; checking whether the flow information is included in predetermined QoS limitation information when there is the previous flow information matched with the flow information; and processing a corresponding packet, from which the flow information is extracted, by applying previous QoS policy information matched with the previous flow information when the flow information is included in predetermined QoS limitation information, and processing the corresponding packet without applying the previous QoS policy information when the flow information is not included in the QoS limitation information.

The operation method of the flow switch according to the exemplary embodiment has advantages in that it is possible to provide a service of which a quality of service (QoS) for a packet and a virtual machine is secured, and prevent deterioration of a service quality for another packet and another virtual machine by extracting flow information of each of a plurality of packets transmitted from hypervisors and using the flow information and information about a virtual machine generating the packet from which the flow information is extracted.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a system diagram schematically illustrating a network system including a flow switch according to an exemplary embodiment.

FIG. 2 is a control block diagram illustrating a control configuration of the flow switch illustrated in FIG. 1.

FIG. 3 is a flowchart illustrating an operating method of the flow switch according to the exemplary embodiment.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, an exemplary embodiment according to the present invention will be described in detail with reference to the accompanying drawings. First, in denoting reference numerals to constitutional elements of respective drawings, the same elements will be designated by the same reference numerals although they are shown in different drawings. In the following description of the present invention, a detailed description of known configurations or functions incorporated herein will be omitted when it is determined that the detailed description may make the subject matter of the present invention unclear. An exemplary embodiment of the present invention will be described below, but the technical spirit of the present invention is not limited thereto and may be modified and variously implemented by those skilled in the art.

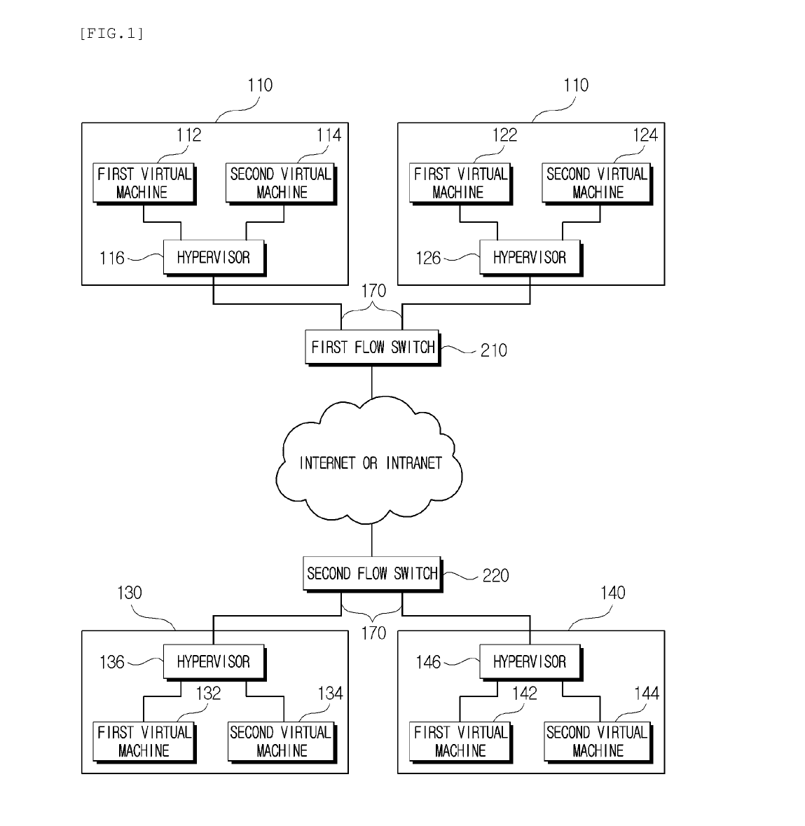

FIG. 1 is a system diagram schematically illustrating a network system including a flow switch according to an exemplary embodiment.

Referring to FIG. 1, a network system may include first to fourth servers 110 to 140, and first and second flow switches 210 and 220.

Here, each of the first to fourth servers 110 to 140 may include first and second virtual machines 112, 114, 122, 124, 132, 134, 142, and 144, and hypervisors 116, 126, 136, and 146.

In the exemplary embodiment, it is represented that each of the first to fourth servers 110 to 140 equally includes two virtual machines, but the number of virtual machines is not limited.

In the exemplary embodiment, it is described that the hypervisors 116, 126, 136, and 146 perform the same configuration and function, but the hypervisors are not limited thereto.

In the exemplary embodiment, the first server 110 will be mainly described, and the second and fourth servers 120 to 140 may perform the similar configuration and function to that of the first server 110, but the servers are not limited thereto.

The first server 110 includes a first virtual machine 112 generating a first packet, a second virtual machine 114 generating a second packet, and a hypervisor 116 receiving the first and second packets generated by the first and second virtual machines 112 and 114 and transmitting the received first and second packets to the first flow switch 210 connected to a network interface 170.

Here, the first and second virtual machines 112 and 114 may be operating systems (OS), for example, LINUX, NetBSD, FreeBSD, Solaris, and Windows, operated in logical hardware (a virtual CPU, a virtual memory, a virtual storage, and a virtual network interface) provided by the hypervisor 116.

The first and second virtual machines 112 and 114 generate the first and second packets according to a demanded service, for example, a web server, a mail server, a file server, a video server, and a cloud server, business finance, finance, and stocks, and the first and second packets include first and second flow information representing the demands for different qualities of service (QoS) according to the demanded services.

The hypervisor 116 virtualizes physical hardware, for example, a CPU, a memory, a storage, and a network interface, and provides the virtualized physical hardware to the first and second virtual machines 112 and 114.

The hypervisor 116 performs a function of a generation, a removal, and a management of resources of the first and second virtual machines 112 and 114, and transmits the first and second packets to the first flow switch 210 through the network interface 170.

In the exemplary embodiment, it is described that the first and second flow switches 210 and 220 perform the same configuration and function, but the first and second flow switches 210 and 220 are not limited thereto, and the configurations and the functions may be different from each other.

The first and second flow switches 210 and 220 may communicate with each other through the Internet or Intranet, but are not limited thereto.

The first flow switch 210 receives the first and second packets transmitted through the network interface 170 connected with the first and second servers 110 and 120.

In this case, the first flow switch 210 receives the first and second packets transmitted from the hypervisor 150, extracts the first flow information from the first packet, and extracts the second flow information from the second packet.

The first flow switch 210 checks whether first and second previous flow information corresponding to the first and second flow information, respectively, is stored in a flow information table stored based on the first and second flow information.

Then, when the first and second previous flow information corresponding to the first and second flow information, respectively, exists, the first flow switch 210 may process the first and second packets according to first and second previous QoS policy information corresponding to the first and second previous flow information, respectively.

Here, when the first and second previous flow information exists, the first flow switch 210 may check whether the first and second previous flow information is included in QoS limitation information set for the first and second packets before the first and second previous QoS policy information is applied, and determine whether to apply the first and second previous QoS policy information.

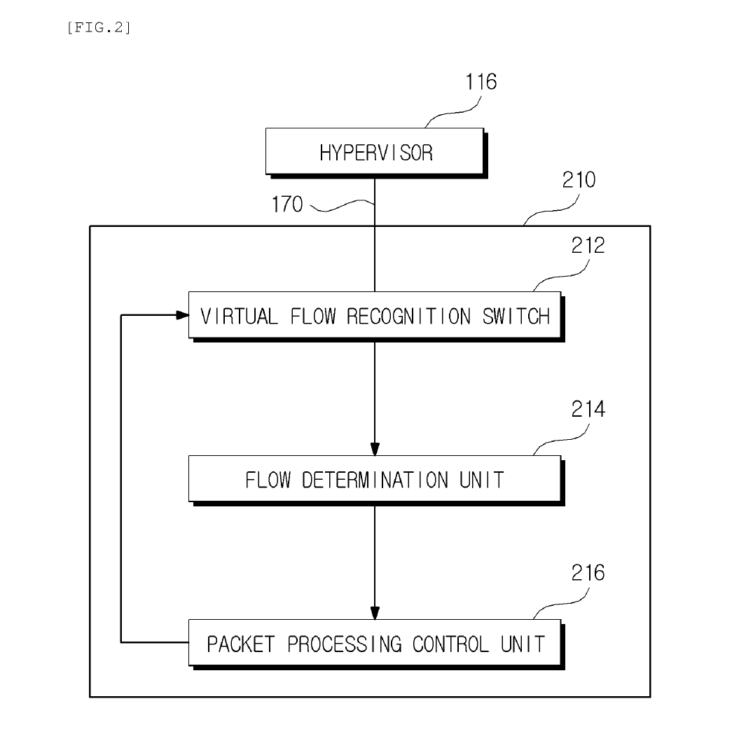

This will be described in detail with reference to FIG. 2 below.

When the first and second previous flow information corresponding to at least one of the first and second flow information does not exist in the flow information table, the first flow switch 210 generates new QoS policy information according to a QoS generation policy set for at least one of the first and second flow information, and processes at least one of the first and second flow information according to the QoS policy information.

Here, the first flow switch 210 may be connected with the second flow switch 220 through the Internet or the Intranet, to receive services for the first and second packets, or provide a service for another packet.

FIG. 2 is a control block diagram illustrating a control configuration of the flow switch illustrated in FIG. 1.

Referring to FIG. 2, the flow switch 210 includes a virtual flow recognition switch 212, a flow determination unit 214, and a packet processing control unit 216.

The virtual flow recognition switch 212 receives the first and second packets transmitted from the hypervisor 116 included in the first server 110 connected through the network interface 170, and transfers the received first and second packets to another virtual flow recognition switch through the Internet or the Intranet according to a control of the packet processing control unit 216 to provide or receive a service.

Here, the virtual flow recognition switch 212 may be a logically virtual switch or a physical switch, but is not limited thereto.

The flow determination unit 214 extracts the first flow information from the first packet received from the virtual flow recognition switch 212, extracts the second flow information from the second packet, and checks whether the first and second previous flow information corresponding to the first and second flow information is stored in a stored previous flow information list.

Here, each of the first and second flow information may include at last one of an IP source address, an IP destination address, a protocol number, source transport information, and destination transport information included in the first and second packets.

The packet processing control unit 216 controls the virtual flow recognition switch 212 so that the first and second packets are processed according to a result of a determination of the flow determination unit 214.

That is, when there is no first and second previous flow information matched with the first and second flow information, respectively, as a result of the determination of the flow determination unit 214, the packet processing control unit 216 generates the first and second QoS policy information according to the QoS generation policy set based on each of the first and second flow information, transmits the first and second QoS policy information to the virtual flow recognition switch 212, and controls the virtual flow recognition switch 212 so that the first and second packets are processed.

In this case, the QoS generation policy may include at least one of the type of services, the amount of bandwidth used, and predetermined user demands based on the first and second flow information.

When there is the first previous flow information matched with the first flow information, and there is no second previous flow information matched with the second flow information as the result of the determination of the flow determination unit 214, the packet processing controller 216 generates the second QoS policy information based on the second flow information and transmits the generated second QoS policy information to the virtual flow recognition switch 212 as described above.

In this case, in a case where there is the first previous flow information matched with the first flow information, the packet processing control unit 216 checks whether the first flow information is included in the predetermined QoS limitation information in order to apply first previous QoS policy information corresponding to the first previous flow information.

That is, in a case where there is the first previous flow information, the packet processing control unit 216 calculates the total amount of bandwidths used for the first and second packets, and the amount of first individual bandwidth used for the first packet.

Then, the packet processing control unit 216 compares the total amount of bandwidths used and a port bandwidth of the network interface 170 included in the QoS limitation information, and when the total amount of bandwidths used is equal to or smaller than the port bandwidth, the packet processing control unit 216 controls the virtual flow recognition switch unit 2112 so that the first packet is processed without applying the first previous QoS information.

When the total amount of bandwidths used is larger than the port bandwidth, the packet processing control unit 216 re-checks whether the amount of total bandwidths used is included in the amount of first individual bandwidth used and an individual bandwidth included in the QoS limitation information, and when the amount of first individual bandwidth used is equal to or smaller than the individual bandwidth, the packet processing control unit 216 controls the virtual flow recognition switch 212 so that the first packet is processed without applying the first previous QoS information.

When the amount of first individual bandwidth used is larger than the individual bandwidth, the packet processing control unit 216 controls the virtual flow recognition switch 212 so that the first packet having the amount of first individual bandwidth used is processed by applying the first previous QoS policy information.

In the exemplary embodiment, the first and second flow information of the first and second packets contains information about the first and second virtual machines 112 and 114 generating the first and second packets, and the flow information table may include at least one of a virtual machine information list and a flow information list.

Accordingly, in a case where the packet processing control unit 216 stores the first and second flow information in the flow information table, the packet processing control unit 216 may make a control so that the first and second flow information is divided and stored in at least one of the virtual machine information list and the flow information list.

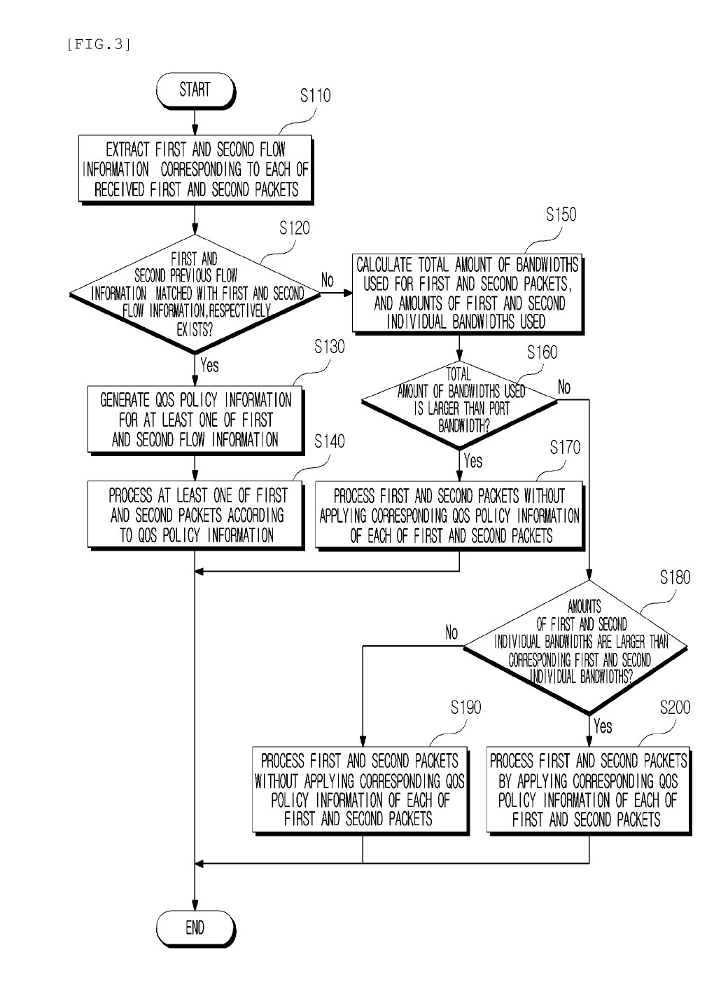

FIG. 3 is a flowchart illustrating an operating method of the flow switch according to the exemplary embodiment.

Referring to FIG. 3, when first and second packets 112 and 114 are transmitted from the hypervisors 116 and 126 through the network interface 170, the flow switch 210 extracts first and second flow information corresponding to the first and second packets 112 and 114, respectively (S110).

That is, the virtual flow recognition switch 212 receives the first and second packets transmitted from the hypervisor 116 included in the first server 110 connected through the network interface 170, and transfers the received first and second packets to another virtual flow recognition switch through the Internet or the Intranet according to a control of the packet processing control unit 216 to provide or receive a service.

The flow determination unit 214 extracts the first flow information from the first packet received by the virtual flow recognition switch 212 and the second flow information from the second packet.

After step S110, the flow switch 210 determines whether the there is stored first and second previous flow information matched with the first and second flow information, respectively (S120), and when there is not first and second previous flow information or the first previous flow information, the flow switch 210 generates each of first and second QoS policy information according to QoS generation policy corresponding to each of the first and second flow information, or generates first QoS policy information according to a QoS generation policy corresponding to the first flow information (S130), and processes the first and second packets according to the first and second QoS policy information or processes the first packet according to the first QoS policy information (S140).

That is, when there is no stored first and second previous flow information matched with the first and second flow information, respectively, or there is no first previous flow information matched with the first flow information among the first and second flow information as a result of the determination of the flow determination unit 214, the packet processing control unit 216 generates the first and second QoS policy information according to a QoS generation policy set based on each of the first and second flow information, or generates the first QoS policy information according to a QoS generation policy set based on the first flow information.

Then, the packet processing control unit 216 transmits the first and second QoS policy information or the first QoS policy information to the virtual flow recognition switch 212, and controls the virtual flow recognition switch 212 so that the first and second packets or the first packet is processed.

When there is the first and second previous flow information or there is only the second previous flow information as the result of the determination of step S120, the flow switch 210 calculates the total amount of bandwidths used for the first and second packets and the amounts of first and second individual bandwidths used for the respective first and second packets (S150).

That is, when there is the stored first and second previous flow information matched with the first and second flow information, respectively or there is only the second previous flow information matched with the second flow information among the first and second flow information as a result of the determination of the flow determination unit 214, the packet processing control unit 216 calculates the total amount of bandwidths used for the first and second packets, and the amounts of first and second individual bandwidths used for the respective first and second packets.

The flow switch 210 compares whether the total amount of bandwidths used calculated in step S150 is larger than a port bandwidth included in predetermined QoS limitation information (S160), when the total amount of bandwidths used is smaller than the port bandwidth, the flow switch 210 controls so as to process the first and second packets or the second packet without applying the first and second previous QoS policy information or the second previous QoS policy information (S170).

That is, when the total amount of bandwidths used is smaller than the port bandwidth included in the predetermined QoS limitation information, for example, a bandwidth of the network interface 170, the packet processing control unit 216 controls so as to process the first and second packets or the second packet without applying the first and second previous QoS policy information or the second previous QoS policy information.

When the total amount of bandwidths used is larger than the port bandwidth in step S160, the flow switch 210 compares the amounts of first and second individual bandwidths used and first and second individual bandwidths included in the QoS limitation information and corresponding to the amounts of respective first and second individual bandwidths used, and compares whether the amounts of first and second individual bandwidths used are larger than the first and second individual bandwidths, respectively, or whether the amount of second individual bandwidth used is larger than the second individual bandwidth (S180). When the amounts of first and second individual bandwidths used are smaller than the first and second individual bandwidths, respectively, or when the amount of second individual bandwidth used is smaller than the second individual bandwidth, the flow switch 210 controls the virtual flow recognition switch 212 so that the first and second packets are processed without applying the first and second previous QoS policy information (S190).

That is, the packet processing control unit 216 compares the first and second individual bandwidths matched with the amounts of first and second individual bandwidths used, respectively, and compares whether the amount of first individual bandwidth used is larger than the first individual bandwidth, or whether the amount of second individual bandwidth used is larger than the second individual bandwidth.

Here, when the amount of first individual bandwidth used is smaller than the first individual bandwidth, and the amount of second individual bandwidth used is smaller than the second individual bandwidth used, the packet processing control unit 216 controls the virtual flow recognition switch 212 so that the first and second packets are processed without applying the first and second previous QoS policy information.

When at least one of the amounts of first and second individual bandwidths used is larger than the first and second individual bandwidths in step S180, the flow switch 210 controls the virtual flow recognition switch 212 so that the first and second packets are processed by applying the first and second previous QoS policy information corresponding to at least one of the corresponding first and second packets (S200).

That is, when both the amounts of first and second individual bandwidths used are larger than the first and second individual bandwidths, the packet processing control unit 216 controls the virtual flow recognition switch 212 so that the first and second packets are processed by applying the first and second previous QoS policy information, and when the amount of first individual bandwidth used is larger than the first individual bandwidth or the amount of second individual bandwidth used is larger than the second individual bandwidth, the packet processing control unit 216 controls the virtual flow recognition switch 212 so that the first and second packets are processed by applying the corresponding first and second previous QoS policy information.

Even if it is described that all of constituent elements constituting the aforementioned exemplary embodiment of the present invention are coupled as a single unit or coupled to be operated as a single unit, the present invention is not necessarily limited to the exemplary embodiment. That is, among all of the constituent elements, one or more constituent elements may be selectively coupled to be operated within the scope of the object of the present invention. Although each of all of the constituent elements may be implemented as an independent hardware, some or all of the constituent elements may be selectively combined with each other, so that they can be implemented as a computer program having a program module for executing some or all of the functions combined in one or more hardware.

All terms used herein including technical or scientific terms have the same meanings as meanings which are generally understood by those skilled in the art unless they are differently defined in the detailed description. Terms generally used, such as terms defined in a dictionary, shall be construed that they have construed as having meanings matching those in the context of a related art, and shall not be construed in ideal or excessively formal meanings unless they are clearly defined in the present application.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A flow switch, comprising:
a virtual flow recognition switch unit configured to receive a plurality of packets transmitted from hypervisors through a network interface, and process the plurality of packets;
a flow determination unit configured to extract flow information corresponding to each of the plurality of packets, and determine whether there is stored previous flow information matched with the flow information; and
a packet processing control unit configured to check whether the flow information is included in predetermined QoS limitation information when there is the previous flow information, control the virtual flow recognition switch unit so that a corresponding packet, from which the flow information is extracted, is processed by applying previous QoS policy information matched with the previous flow information when the flow information is included in the QoS limitation information, and control the virtual flow recognition switch unit so that the corresponding packet is processed without applying the previous QoS policy information when the flow information is not included in the QoS limitation information.

2. The flow switch of claim 1, wherein the flow determination unit extracts the flow information including at least one of an IP source address, an IP destination address, a protocol number, source transport information, and destination transport information included in each of the plurality of packets.

3. The flow switch of claim 1, wherein the packet processing control unit calculates the total amount of bandwidths used for the plurality of packets and the amount of individual bandwidth used for each of the plurality of packets when there is the previous flow information, and determines whether at least one of the total amount of bandwidths used and the amount of individual bandwidth used is included in the QoS limitation information.

4. The flow switch of claim 3, wherein when the total amount of bandwidths used is equal to or smaller than a port bandwidth of the network interface included in the QoS limitation information, the packet processing control unit checks that the plurality of packets is included to the QoS information, and processes each of the plurality of packets without applying the previous QoS information.

5. The flow switch of claim 3, wherein when the total amount of bandwidths used is larger than a port bandwidth of the network interface included in the QoS limitation information, the packet processing control unit re-checks whether the amount of individual bandwidth used for each of the plurality of packets is included in an individual bandwidth of each of the plurality of packets included in the QoS limitation information, and when the total amount of bandwidths used is equal to or smaller than the individual bandwidth of each of the plurality of packets corresponding to the amount of individual bandwidth used for each of the plurality of packets, the packet processing control unit confirms that the plurality of packets is included in the QoS information to process each of the plurality of packets without applying the previous QoS information.

6. The flow switch of claim 5, wherein when at least one of the amounts of respective individual bandwidths used is larger than a corresponding individual bandwidth, the packet processing control unit processes the plurality of packets by applying the previous QoS policy information matched with at least one packet having the amount of at least one bandwidth used among the plurality of packets.

7. The flow switch of claim 1, wherein when there is no previous flow information matched with the flow information as a result of the determination of the flow determination unit, the packet processing control unit generates QoS policy information according to a QoS generation policy set based on the flow information, and transmits the QoS policy information to the virtual flow recognition switch unit so that the corresponding packet, from which the flow information is extracted, is processed.

8. A method of operating a flow switch, comprising:
extracting flow information corresponding to each of a plurality of packets when the plurality of packets is transmitted from hypervisors through a network interface;
determining whether there is stored previous flow information matched with the flow information;
checking whether the flow information is included in predetermined QoS limitation information when there is the previous flow information matched with the flow information; and
processing a corresponding packet, from which the flow information is extracted, by applying previous QoS policy information matched with the previous flow information when the flow information is included in QoS limitation information, and processing the corresponding packet without applying the previous QoS policy information when the flow information is not included in the QoS limitation information.

9. The method of claim 8, wherein the extraction includes extracting the flow information including at least one of an IP source address, an IP destination address, a protocol number, source transport information, and destination transport information included in each of the plurality of packets.

10. The method of claim 8, wherein the checking includes:
calculating the total amount of bandwidths used for the plurality of packets and the amount of individual bandwidth used for each of the plurality of packets; and
determining whether at least one of the total amount of bandwidths used and the amount of individual bandwidth used is included in the QoS limitation information.

11. The method of claim 10, wherein the determining includes:
comparing whether the total amount of bandwidths used is larger than a port bandwidth of the network interface included in the QoS limitation information; and
when the total amount of bandwidths used is equal to or smaller than a port bandwidth, processing each of the plurality of packets without applying the previous QoS policy information.

12. The method of claim 11, wherein the processing includes:
when the total amount of bandwidths used is larger than the port bandwidth, comparing whether the amount of individual bandwidth used for each of the plurality of packets is larger than an individual bandwidth of each of the plurality of packets included in the QoS limitation information; and
when the amount of individual bandwidth used is equal to or smaller than the individual bandwidth, processing each of the plurality of packets without applying the previous QoS policy information.

13. The method of claim 12, further comprising:
when at least one of the amounts of respective individual bandwidths used is larger than the corresponding individual bandwidth, processing the plurality of packets by applying the previous QoS policy information matched with at least one packet having the amount of at least one bandwidth used.

14. The method of claim 8, further comprising:
after the determining, when the previous flow information matched with the flow information does not exist, generating QoS policy information according to a QoS generation policy set based on the flow information; and
storing the QoS policy information.
